(19) United States
(12) Patent Application Publication
(10) Pub. No.: US 2002/0057539 A1
(43) Pub. Date: May 16, 2002

(54) Magnetoresistive head

(76) Inventors: Satoshi Ajiki, Yamagata (JP); Koichi Hosoya, Yamagata (JP)

Correspondence Address: McGuire Woods, Suite 1800, 1750 Tysons Boulevard, McLean, VA, 22102-3915, US

(21) Appl. No.: 09/935,674

(22) Filed: Aug. 24, 2001

(30) Foreign Application Priority Data
Aug. 25, 2000 (JP) P.2000-256082

(51) Int. Cl. G11B 5/39

(52) U.S. Cl. 360/327.3

(57) ABSTRACT

A magnetoresistive element is formed by laminating a soft magnetic bias gap layer, a soft magnetic bias layer, a magnetic separation layer, a magnetoresistive layer and a magnetoresistive gap layer, so as to define a sliding surface on which a tape-shaped magnetic recording medium is slid. An upper shield layer and a lower shield layer vertically sandwich the magnetoresistive element therebetween. A vertically stepped portion is provided on each of the upper or the lower shield layer and the respective layers forming the magnetoresistive element, so as to extend horizontally in a track width direction of the sliding surface.

### BACKGROUND OF THE INVENTION

The present invention relates to a magnetoresistive head, in particular, relates to a magnetoresistive head with a large track width used in a tape type recording apparatus.

FIG. 5 shows one example of a related magnetoresistive head (hereinafter called an MR head). The MR head 20 is configured by a non-magnetic substrate 21, a bottom shield 22 formed on the non-magnetic substrate 21, an MR element 23 sandwiched between the bottom shield 22 and an upper shield 24, a coil 25, an upper magnetic layer 26 and a write gap 27 etc.

FIG. 6 is an enlarged front view of the MR element 23. The MR element 23 is sandwiched by vertical bias sections 28 each formed by an electrode layer 28a and a magnetic domain control film 28b. The MR element 23 is configured by laminating a soft magnetic bias layer (SAL) 30, a separation (non-magnetic) layer 31 serving as a magnetic separation layer, a magnetoresistive layer 32 made of FeNi etc., and a magnetoresistive gap layer 33.

FIG. 7 is a plan view of the MR element 23 shown in FIG. 6. As shown in this figure, the MR element 23 is sandwiched by the vertical bias sections 28. The vertical bias section 28 serves to apply predetermined bias magnetic field to the MR element 23 to thereby control the magnetizing direction within the MR element 23. FIG. 8 is a sectional view taken along a line B-B′ in FIG. 7. As shown in FIG. 8, the soft magnetic bias layer 30, the separation layer 31, the magnetoresistive layer 32 and the magnetoresistive gap layer 33 constituting the MR element 23 are laminated almost horizontally in parallel with the bottom shield 22 and the upper shield 24.

In recent years, the MR heads each having the aforesaid configuration have been widely employed in the tape type recording apparatuses such as tape streamers as well as the disk type recording apparatuses such as hard disc driving apparatuses. The MR head for reproducing information from a tape-shaped recording medium has a wider track width and a greater MR height than those of the MR head for the apparatus for a disk-shaped recording medium. In such a head having a wide track width, the intensity of the biasing magnetic field is large near the vertical bias section 28 but is attenuated as being away from the vertical bias section 28, and the vertical biasing effect is degraded at the center portion of the track. Accordingly, the magnetizing direction within the MR element can not be controlled, thereby the reproduction characteristics of the MR head is deteriorated.

### SUMMARY OF THE INVENTION

It is therefore an object of the invention is to provide a magnetoresistive head which can effectively control the magnetizing direction at the center portion of a track and obtain good reproduction characteristics, in particular, in a magnetoresistive head having a large track width used in the tape type recording apparatus or the like.

In order to achieve the above object, according to the present invention, there is provided a magnetoresistive head, comprising:

a magnetoresistive element, formed by laminating a soft magnetic bias gap layer, a soft magnetic bias layer, a magnetic separation layer, a magnetoresistive layer and a magnetoresistive gap layer, so as to define a sliding surface on which a tape-shaped magnetic recording medium is slid;

an upper shield layer and a lower shield layer, which vertically sandwich the magnetoresistive element therebetween,

wherein a vertically stepped portion is provided on each of the upper shield layer and the respective layers forming the magnetoresistive element, so as to extend horizontally in a track width direction of the sliding surface.

Here, it is preferable that a dimension of the vertically stepped portion falls within a range of 5 to 100 nm.

Alternatively, a vertically stepped portion may be provided on each of the lower shield layer and the respective layers forming the magnetoresistive element, so as to extend horizontally in a track width direction of the sliding surface.

Similarly, it is preferable that a dimension of the vertically stepped portion falls within a range of 5 to 100 nm.

Still alternatively, a vertically convex portion may be provided on the respective layers forming the magnetoresistive element, so as to extend horizontally in a track width direction of the sliding surface.

Here, it is preferable that a dimension of the vertically convex portion falls within a range of 5 to 100 nm.

In the above configurations, the shape induced magnetic anisotropy of the MR element is enhanced so that the magnetizing direction of the portion near the center of the sliding surface where the vertical bias effect is degraded can be controlled.

Therefore, even in the magnetoresistive head having a large track width used in the tape type recording apparatus etc., the magnetizing direction at the center portion of the track can be controlled effectively, so that good reproduction characteristics can be realized.

### BRIEF DESCRIPTION OF THE DRAWINGS

The above objects and advantages of the present invention will become more apparent by describing in detail preferred exemplary embodiments thereof with reference to the accompanying drawings, wherein like reference numerals designate like or corresponding parts throughout the several views, and wherein:

FIG. 1 is a plan view of an MR element of an MR head according to a first embodiment of the invention;

FIG. 2 is a sectional view of the MR head shown in FIG. 1;

FIG. 3 is a sectional view showing an MR head according to a second embodiment of the invention;

FIG. 4 is a sectional view showing an MR head according to a third embodiment of the invention;

FIG. 5 is an exploded perspective view a related MR head;

FIG. 6 is a front view of the related MR element;

FIG. 7 is a plan view of the related MR element; and

FIG. 8 is a sectional view of the related MR element.

### DETAILED DESCRIPTION OF THE PREFERRED EMBODIMENTS

A magnetoresistive head (hereinafter called an MR head) according to the invention will be explained in detail with reference to the accompanying drawings.

FIG. 1 is a plan view of an MR element 1 provided with an MR head according to a first embodiment of the invention. The MR head is attached to a tape type recording apparatus such as a tape streamer etc. The MR element 1 has a sliding surface 1a on which a tape-shaped recording medium slides. The track width w of the MR element 1 is formed to be larger than that of an MR head mounted on a hard disc driving apparatus etc. Vertical bias sections 2 for applying magnetic filed to the MR element 1 are provided so as to sandwich the MR element 1. The vertical bias section 2 is formed by an electrode layer and a magnetic domain control film as discussed the above. In this embodiment, a step portion 1b extends in the width direction of the MR element 1 as discussed later.

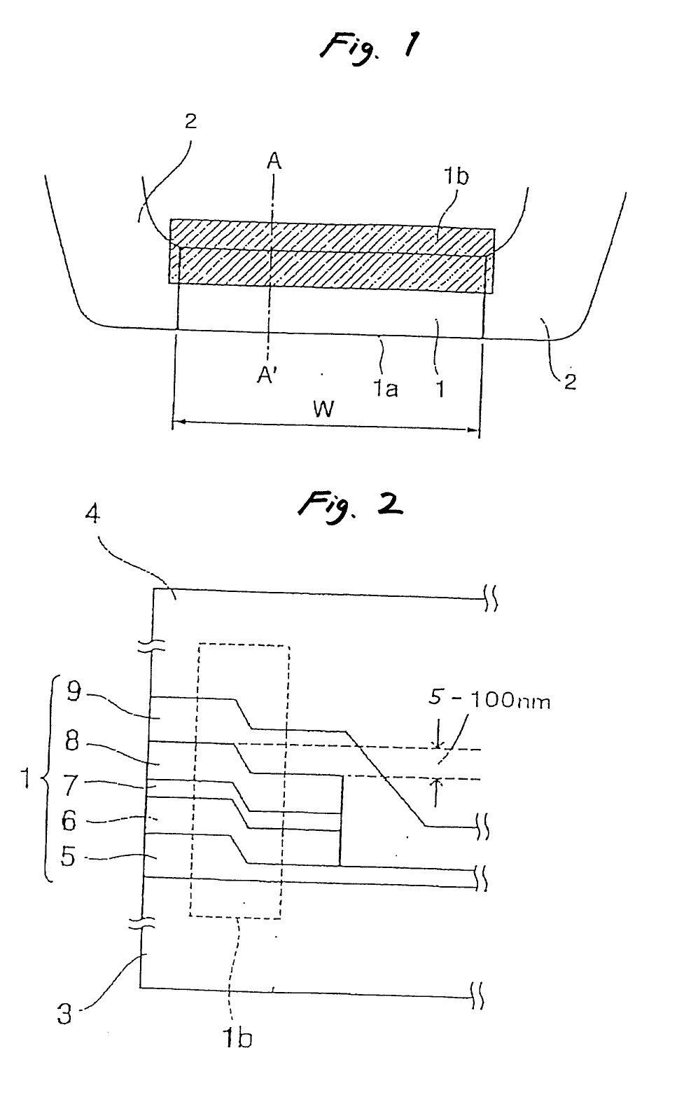

FIG. 2 is a sectional view along a line A-A′ of the MR element 1. As shown in FIG. 2, the MR element 1 is sandwiched between a bottom shield 3 and an upper shield 4, and configured by sequentially laminating a soft magnetic bias gap layer 5, a soft magnetic bias layer (SAL) 6, a separation (non-magnetic) layer 7, a magnetoresistive layer 8 and a magnetoresistive gap layer 9.

In the MR element 1, the soft magnetic bias layer 6 formed on the soft magnetic bias gap layer 5 applies bias to the magnetoresistive layer 8. The separation layer 7 formed on the soft magnetic bias layer 6 is used as a magnetic separation layer. The magnetoresistive layer 8 detects magnetic information recorded on the tape-shaped magnetic recording medium in the form of change of an electric resistance value. The well-known technique such as the spattering method etc. is employed for laminating these respective layers, so that the explanation thereof is omitted.

Each of the upper shield 4 and the respective layers in the MR element 1 has the step portion 1b having a height in a range of 5 to 100 nm and extending in the track width direction. In the related MR element, there was a problem that when the track width is made larger, the vertical biasing effect is degraded at the center portion of the track, so that the magnetizing direction within the MR element can not be controlled. However, according to this embodiment, since the shape induced magnetic anisotropy of the MR element is enhanced by providing the step portion 1b, the axis of easy magnetization within the MR element 1 is directed to the track width direction. In general, it is considered that when a shape of the MR element is elongated, the magnetizing direction is directed to the elongated direction. Like this consideration, when the step portion 1b is provided in FIG. 1, the step portion and the flat portion are magnetically separated. As a result, the MR element 1 can be regarded as an MR element having an elongated shape. It is thus considered that the shape induced magnetic anisotropy effect is enhanced, and that the magnetizing direction is directed to the track width direction. Thus, according to the invention, the magnetizing direction at the portion near the center portion of the track where the vertical biasing effect is degraded can be controlled suitably.

That is, according to the invention, even in the MR head in which the track width and the MR height corresponding to the tape type recording apparatus are relatively large, the magnetizing direction within the MR element can be suitably controlled, so that the MR head with good reproduction characteristics can be realized.

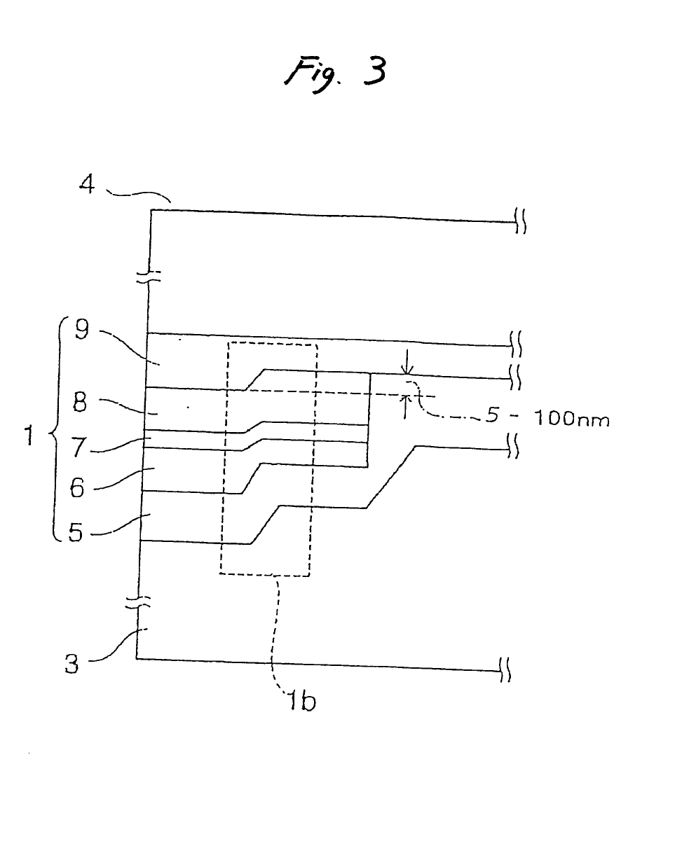

FIG. 3 is a diagram showing a second embodiment of the invention. In this figure, portions common to those of FIG. 2 are referred to by the identical symbols, and the explanation of the functions thereof are omitted. In the embodiment shown in FIG. 2, the step portion 1b is provided at each of the upper shield 4 and the respective layers of the MR element 1. In contrast, in this embodiment, a step portion is provided in the direction opposite to that of the first embodiment in each of the bottom shield 3 and the respective layers of the MR element 1. Even when the direction of the step of the step portion 1b is made in opposite to that of the first embodiment in this manner, the shape induced magnetic anisotropy of the MR element 1 can be enhanced. Thus, the axis of easy magnetization within the MR element 1 is directed to the track width direction and the magnetizing direction within the MR element can be suitably controlled, so that the MR head with good reproduction characteristics can be realized.

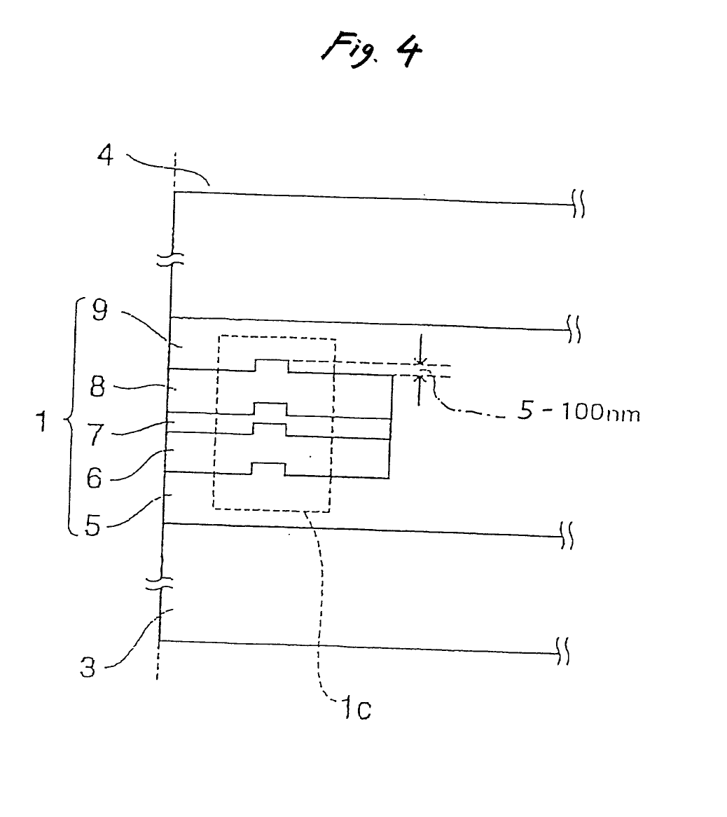

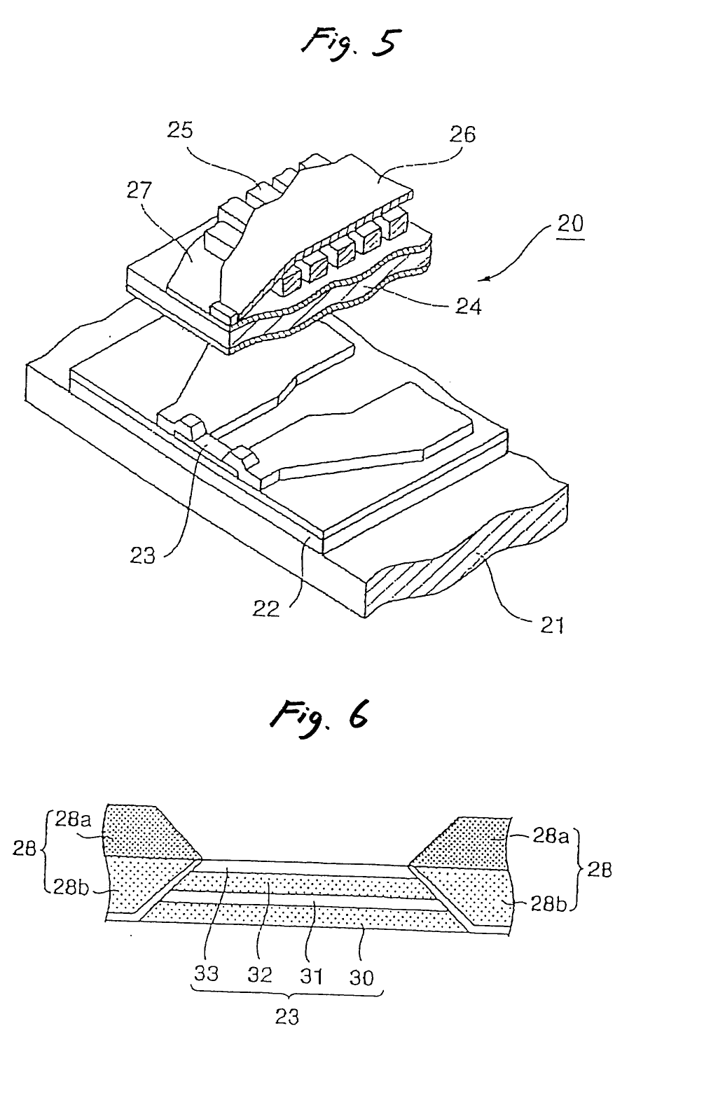

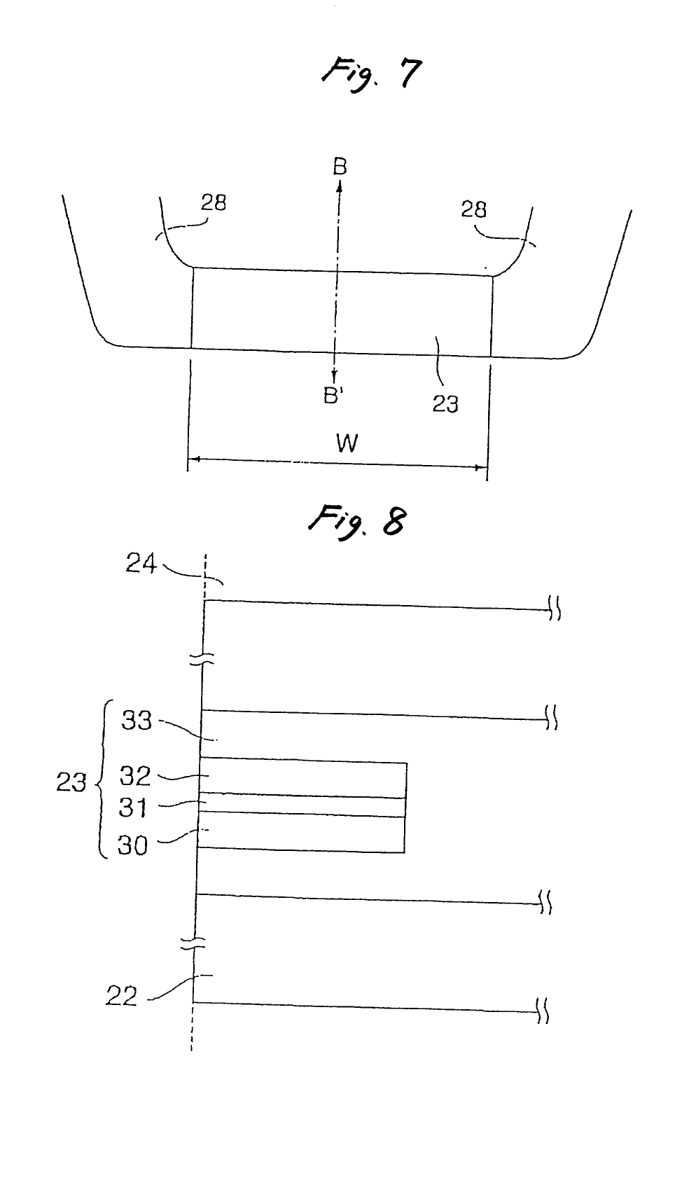

FIG. 4 is a diagram showing a third embodiment of the invention. In this MR head, the basic configuration of the MR element 1 is same as those of the aforesaid first and second embodiments. Thus, in this figure, portions common to those of the aforesaid embodiments are referred to by the identical symbols, and the explanation thereof are omitted. In the third embodiment, each of a soft magnetic bias gap layer 5, a soft magnetic bias layer 6, a separation layer 7 and a magnetoresistive layer 8 is provided with a convex-shaped step portion 1c formed in the track width direction of the MR element 1. According to such a convex-shaped step portion 1c, the shape induced magnetic anisotropy of the MR element 1 can also be enhanced. Thus, the axis of easy magnetization within the MR element 1 is directed to the track width direction and the magnetizing direction within the MR element can be suitably controlled, so that the MR head with good reproduction characteristics can be realized.

Although the present invention has been shown and described with reference to specific preferred embodiments, various changes and modifications will be apparent to those skilled in the art from the teachings herein. Such changes and modifications as are obvious are deemed to come within the spirit, scope and contemplation of the invention as defined in the appended claims.

What is claimed is:

1. A magnetoresistive head, comprising:
a magnetoresistive element, formed by laminating a soft magnetic bias gap layer, a soft magnetic bias layer, a magnetic separation layer, a magnetoresistive layer and a magnetoresistive gap layer, so as to define a sliding surface on which a tape-shaped magnetic recording medium is slid;
an upper shield layer and a lower shield layer, which vertically sandwich the magnetoresistive element therebetween,
wherein a vertically stepped portion is provided on each of the upper shield layer and the respective layers forming the magnetoresistive element, so as to extend horizontally in a track width direction of the sliding surface.

2. The magnetoresistive head as set forth in claim 1, wherein a dimension of the vertically stepped portion falls within a range of 5 to 100 nm.

3. A magnetoresistive head, comprising:
a magnetoresistive element, formed by laminating a soft magnetic bias gap layer, a soft magnetic bias layer, a magnetic separation layer, a magnetoresistive layer and a magnetoresistive gap layer, so as to define a sliding surface on which a tape-shaped magnetic recording medium is slid;
an upper shield layer and a lower shield layer, which vertically sandwich the magnetoresistive element therebetween,
wherein a vertically stepped portion is provided on each of the lower shield layer and the respective layers forming the magnetoresistive element, so as to extend horizontally in a track width direction of the sliding surface.

4. The magnetoresistive head as set forth in claim 3, wherein a dimension of the vertically stepped portion falls within a range of 5 to 100 nm.

5. A magnetoresistive head, comprising:
a magnetoresistive element, formed by laminating a soft magnetic bias gap layer, a soft magnetic bias layer, a magnetic separation layer, a magnetoresistive layer and a magnetoresistive gap layer, so as to define a sliding surface on which a tape-shaped magnetic recording medium is slid;
an upper shield layer and a lower shield layer, which vertically sandwich the magnetoresistive element therebetween,
wherein a vertically convex portion is provided on the respective layers forming the magnetoresistive element, so as to extend horizontally in a track width direction of the sliding surface.

6. The magnetoresistive head as set forth in claim 5, wherein a dimension of the vertically convex portion falls within a range of 5 to 100 nm.
